(19) United States
(12) Patent Application Publication
(10) Pub. No.: US 2020/0184852 A1
(43) Pub. Date: Jun. 11, 2020

(54) TILED GLOBE ASSEMBLY

(71) Applicant: Global Creations, LLC, St. Louis Park, MN (US)

(72) Inventors: Matthew Hartloff, St. Louis Park, MN (US); Brian Lukis, Eden Prairie, MN (US)

(21) Appl. No.: 16/640,614

(22) PCT Filed: Aug. 23, 2018
(86) PCT No.: PCT/US2018/047662

§ 371 Date: Feb. 20, 2020

Related U.S. Application Data
(63) Continuation-in-part of application No. 29/614,830, filed on Aug. 23, 2017.
(60) Provisional application No. 62/563,934, filed on Sep. 27, 2017.
(60) Provisional application No. 62/549,809, filed on Aug. 24, 2017.

(51) Int. Cl. G09B 27/08

(52) U.S. Cl. CPC G09B 27/08; A63F 9/1208

(57) ABSTRACT

A globe can include a plurality of pieces structured to inter-attach to form a surface of the globe, and an attachment system. Each piece can be substantially rigid, and can have an outer major surface shaped to form a portion of the surface of the globe. The plurality of pieces can include a first quantity of substantially identically-shaped polygonal pieces. The attachment system can be configured to attach at least some adjacent edges of the pieces, and can attach at least one edge of each of the pieces to an adjacent edge of another of the pieces. The attachment system can be configured such that the globe has sufficient structural integrity to substantially maintain a globular shape under its own weight. Each of a majority of the pieces can include a printed image on its outer major surface that is different than any printed image of any other piece.

### CROSS-REFERENCE TO RELATED APPLICATIONS

This application claims the benefit of U.S. Design patent application Ser. No. 29/614,830 filed Aug. 23, 2017 and titled TILED GLOBE ASSEMBLY, U.S. Provisional Application No. 62/549,809 filed Aug. 24, 2017 and titled TILED GLOBE ASSEMBLY, and U.S. Provisional Application No. 62/563,934 filed Sep. 27, 2017 and titled TILED GLOBE ASSEMBLY, which are hereby incorporated by reference.

### FIELD OF THE DISCLOSURE

This disclosure relates to globes, and more particularly, to globes that can readily be printed with surface features.

### BACKGROUND OF THE INVENTION

Globes provide formats for appreciating spatial information with distinct advantages over more common two-dimensional flat media. Traditional methods of globe production have disadvantages that can make it difficult to manufacture accurate globes, and producing custom globes can be cost prohibitive. It would be desirable to provide globes and methods for making globes that lower the barriers to producing accurate globes and custom globes.

### SUMMARY OF THE INVENTION

This disclosure relates to globes, and more particularly, to globes that can readily be printed with surface features. In an illustrative but non-limiting example, the disclosure provides a globe that can include a plurality of pieces structured to inter-attach to form a surface of the globe, and an attachment system. Each of the plurality of pieces can be substantially rigid, and each of the plurality of pieces can have an outer major surface that is shaped to form a portion of the surface of the globe. The plurality of pieces can include at least a first quantity of substantially identically-shaped M-sided polygonal pieces. The attachment system can be structured and configured to attach at least some adjacent edges of the plurality of pieces. The attachment system can attach at least one edge of each of the plurality of pieces to an adjacent edge of another of the plurality of pieces. The attachment system can be configured such that the globe has sufficient structural integrity to substantially maintain a globular shape under its own weight. Each of a majority of the plurality of pieces can include a printed image on its outer major surface that is different than any printed image of any of the other of the plurality of pieces.

In some examples, the plurality of pieces can include a second quantity of substantially identically-shaped N-sided polygonal pieces. In some such examples, each piece of the first quantity of substantially identically-shaped M-sided polygonal pieces can be bounded by edges that demark a substantially regular polygon, and each piece of the second quantity of substantially identically-shaped N-sided polygonal pieces can be bounded by edges that demark one of a regular polygon or a quasi-regular polygon. A quasi-regular polygon is defined in the present disclosure as having alternating edges of a first length and of a second length, and equal angles between all edges.

In some of the examples having a second quantity of substantially identically-shaped N-sided polygonal pieces, each piece of the second quantity of substantially identically-shaped N-sided polygonal pieces are bounded by edges that demark a quasi-regular polygon.

In some of the examples having a second quantity of substantially identically-shaped N-sided polygonal pieces the first quantity of M-sided polygonal pieces and the second quantity of N-sided polygonal pieces, when inter-attached to form the surface of the globe, exhibit a tessellation pattern derived from a truncated Platonic solid. In some of these examples exhibiting a tessellation pattern derived from a truncated Platonic solid, the M-sided polygonal pieces are pentagons, and the N-sided polygonal pieces are hexagons. In some of these examples, the first quantity of pentagons is twelve, the second quantity of hexagons is twenty, and the N-sided polygonal pieces are quasi-regular hexagons. In some others of the examples exhibiting a tessellation pattern derived from a truncated Platonic solid, the M-sided polygonal pieces are squares, and the N-sided polygonal pieces are hexagons. In some of these examples, the first quantity of squares is six, the second quantity of hexagons is eight, and the N-sided polygonal pieces are quasi-regular hexagons.

In some examples, for at least some of the plurality of pieces, at least a portion of the outer major surface is shaped flatter than a reference spherical globe surface. In some of these examples, for the pieces for which at least a portion of the outer major surface is shaped flatter than a reference spherical globe surface, a maximum drop for the outer major surfaces of the pieces does not exceed a pre-determined value, which in some cases can be about 8.0 mm.

In some examples, the attachment system can include polarized attachment devices. In some of these examples, the polarized attachment devices can include magnets.

In some examples, for each of the majority of the plurality of pieces that includes a printed image on its outer major surface, the printed image can be printed directly upon the outer major surface.

In another illustrative but non-limiting example, the disclosure provides a method for providing a photo globe that can include providing a plurality of pieces structured to inter-attach to form a surface of a globe, printing onto the pieces, and providing an attachment system for the pieces. Each of the plurality of pieces can be substantially rigid, and each of the plurality of pieces can have an outer major surface that is shaped to form a portion of the surface of the globe. The plurality of pieces can include at least a first quantity of substantially identically-shaped M-sided polygonal pieces. Printing, which can include inkjet printing, can include printing directly onto the outer major surface of each of a majority of the plurality of pieces an image that is unique for each printed piece. The attachment system can be structured and configured to attach at least some adjacent edges of the plurality of pieces. The attachment system can be configured such that the globe, when assembled via inter-attachment of pieces via the attachment system, has sufficient structural integrity to substantially maintain a globular shape under its own weight.

Some examples of the method can further include selecting a printer technology for the printing, and providing a plurality of pieces can include selecting dimensions for the pieces of the plurality of pieces such that the maximum drop for any of the pieces does not exceed a value that would result in print quality below a selected quality level for the selected printer technology. In some cases, the maximum drop for any of the pieces does not exceed 8.0 mm. In some cases, selecting dimensions for the pieces of the plurality of pieces includes at least one of selecting a truncation level, and specifying flattening of the outer major surfaces of at least some of the plurality of pieces.

In some examples of the method, providing an attachment system can include integrating magnets with each of the plurality of pieces.

In another illustrative but non-limiting example, the disclosure provides a globe that can include a plurality of pieces structured to inter-attach to form a surface of the globe, and an attachment system. Each of the plurality of pieces can be substantially rigid, and each of the plurality of pieces can have an outer major surface that is shaped to form a portion of the surface of the globe. Each of the plurality of pieces can be bounded by edges that demark a substantially regular polygon, with all of the edges of all of the plurality of pieces having substantially identical length. The plurality of pieces can include a first quantity of pentagonal pieces and a second quantity of hexagonal pieces. In some cases, the first quantity of pentagonal pieces is twelve and the second quantity of hexagonal pieces is twenty. The attachment system can be structured and configured to attach at least some adjacent edges of the plurality of pieces. The attachment system can attach at least one edge of each of the plurality of pieces to an adjacent edge of another of the plurality of pieces. The attachment system can be configured such that the globe has sufficient structural integrity to substantially maintain a spherical shape under its own weight.

In some examples, the attachment system can include attachment devices structured and configured to provide reversible and repeatable attachments.

In some examples, the attachment system can include non-polarized attachment devices.

In some examples, the attachment system can include polarized attachment devices. In some cases, polarized attachment devices can include hook-and-loop fasteners. In some cases, polarized attachment devices can include magnets. In some cases, every edge of each pentagonal piece can include a polarized attachment device of a first polarity, and every other edge of each hexagonal piece can include a polarized attachment device of a second polarity.

In some examples, each of a majority of the plurality of pieces can include a printed image on its outer major surface that is different than any printed image of any of the other of the plurality of pieces.

In another illustrative but non-limiting example, the disclosure provides a method for providing a photo globe that can include providing a plurality of pieces structured to inter-attach to form a surface of a globe, printing onto the pieces, and providing an attachment system for the pieces. Each of the plurality of pieces can be substantially rigid, and each of the plurality of pieces can have an outer major surface that is shaped to form a portion of the surface of the globe. Each of the plurality of pieces being can be bounded by edges that demark a substantially regular polygon, with all of the edges of all of the plurality of pieces having substantially identical length. The plurality of pieces can include a first quantity of pentagonal pieces and a second quantity of hexagonal pieces. Printing, which can include inkjet printing, can include printing directly onto the outer major surface of each of a majority of the plurality of pieces an image that is unique for each printed piece. The attachment system can be structured and configured to attach at least some adjacent edges of the plurality of pieces. The attachment system can be configured such that the globe, when assembled via inter-attachment of pieces via the attachment system, has sufficient structural integrity to substantially maintain a spherical shape under its own weight.

In some examples of the method, providing an attachment system can include integrating magnets with each of the plurality of pieces. This can include integrating a magnet with each edge of each of the first quantity of pentagonal pieces, with the magnet exhibiting an outward-facing pole of a first kind, and integrating a magnet with every other edge of each of the second quantity of hexagonal pieces, with the magnet exhibiting an outward-facing pole of a second kind.

Some examples of the method can further include selecting a printer technology for the printing, and providing a plurality of pieces can include selecting dimensions for the pieces of the plurality of pieces such that the maximum drop for any of the pieces does not exceed a value that would result in print quality below a selected quality level for the selected printer technology. In some cases, the maximum drop for any of the pieces does not exceed 8.0 mm.

In another illustrative but non-limiting example, the disclosure provides an image globe that can include thirty-two substantially rigid pieces structured to inter-attach to form a surface of a globe. Each of the substantially rigid pieces can have an outer major surface that is shaped to form a portion of the surface of the globe, and each of the substantially rigid pieces can be bounded by edges that demark a substantially regular polygon. All of the edges of all of the substantially rigid pieces can have substantially identical length. The thirty-two substantially rigid pieces can include twelve pentagonal pieces and twenty hexagonal pieces. Each pentagonal piece can have five magnets, where each edge of the pentagonal piece includes one of the five magnets integrated with the edge, with the magnet exhibiting an outward-facing magnet pole of a first kind. Each hexagonal piece can have three magnets, where every other edge of the hexagonal piece includes one of the three magnets integrated with the edge, with the magnet exhibiting an outward-facing magnet pole of a second kind. The thirty-two substantially rigid pieces can be assemblable to form the globe with the magnets providing sufficient attachment force between the substantially rigid pieces such that the globe so-assembled has sufficient structural integrity to substantially maintain a spherical shape under its own weight.

In some examples, each of a majority of the thirty-two substantially rigid pieces can include a printed image on its outer major surface that is different than any printed image of any of the other of the thirty-two substantially rigid pieces.

In some examples, each edge of each of the pentagonal and hexagonal pieces has a length not greater than about 1.5 inches.

In another illustrative but non-limiting example, the disclosure provides a globe that can include a plurality of pieces structured to inter-attach to form a surface of the globe, and an attachment system. Each of the plurality of pieces can be substantially rigid, and each of the plurality of pieces can have an outer major surface that is shaped to form a portion of the surface of the globe. The plurality of pieces can include a first quantity of substantially identically-shaped M-sided polygonal pieces, with each M-sided polygonal piece being bounded by edges that demark a substantially regular polygon, and a second quantity of substantially identically-shaped N-sided polygonal pieces, with each N-sided polygonal piece being bounded by edges that demark an at least quasi-regular polygon. The first quantity of M-sided polygonal pieces and the second quantity of N-sided polygonal pieces, when inter-attached to form the surface of the globe, can embody a tessellation pattern derived from a truncated Platonic solid. The attachment system can be structured and configured to attach at least some adjacent edges of the plurality of pieces. The attachment system can attach at least one edge of each of the plurality of pieces to an adjacent edge of another of the plurality of pieces. The attachment system can be configured such that the globe has sufficient structural integrity to substantially maintain a globular shape under its own weight.

In some examples, each N-sided polygonal piece is bounded by edges that demark a substantially regular polygon. In other examples, each N-sided polygonal piece is bounded by N/2 edges of a first length and N/2 edges of a second length, further wherein each M-sided polygonal piece is bounded by M edges of the first length.

In some examples, the M-sided polygonal pieces are pentagons, and the N-sided polygonal pieces are hexagons. In some of these examples, the first quantity of pentagons is twelve, and the second quantity of hexagons is twenty.

In some examples, the M-sided polygonal pieces are squares, and the N-sided polygonal pieces are hexagons. In some of these examples, the first quantity of squares is six, and the second quantity of hexagons is eight.

In some examples, the globe is a substantially spherical globe.

In some examples, each of a majority of the plurality of pieces includes an image printed directly on its outer major surface that is different than any image printed on any of the other of the plurality of pieces.

The above summary is not intended to describe each and every example or every implementation of the disclosure. The Description that follows more particularly exemplifies various illustrative embodiments.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a schematic perspective view of a globe assembly of the present disclosure;

FIG. 2 is a schematic top plan view of a pentagonal piece of the globe assembly of FIG. 1;

FIG. 3 is a schematic bottom plan view of the pentagonal piece of FIG. 2;

FIG. 4 is a schematic side perspective view of the pentagonal piece of FIG. 2;

FIG. 5 is a schematic bottom perspective view of the pentagonal piece of FIG. 2;

FIG. 6 is a schematic top plan view of a hexagonal piece of the globe assembly of FIG. 1;

FIG. 7 is a schematic bottom plan view of the hexagonal piece of FIG. 6;

FIG. 8 is a schematic side perspective view of the hexagonal piece of FIG. 6;

FIG. 9 is a schematic bottom perspective view of the hexagonal piece of FIG. 6;

FIG. 10 is a schematic perspective view of the globe assembly of FIG. 1 that is essentially fully assembled save for a single hexagonal piece;

FIG. 11 is a schematic cross-sectional view of the hexagonal piece of FIG. 6 along the line A-A marked in FIG. 7;

FIG. 12 is a schematic perspective view of another globe assembly of the present disclosure;

FIG. 13 is a schematic perspective view of still another globe assembly of the present disclosure;

FIG. 14 is a schematic side view of a square globe piece;

FIG. 15 is a schematic side view of a square globe piece, similar to the piece of FIG. 14, but differing in the shape of its outer major surface; and

FIG. 16 is a schematic perspective view of multiple globe pieces that are positioned to provide at least a portion of a globe assembly.

### DETAILED DESCRIPTION

The present disclosure relates to globes, and more particularly, to globes that can readily be printed with surface features. Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements; those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

Globe assemblies of the present disclosure can be used, without limitation, for amusement, education, and decorative purposes. A globe of the present disclosure can include a plurality of pieces, segments, or tiles that can be attached to each other to form the globe. In some embodiments of the present disclosure, a globe assembly can be an assemblage of a plurality of substantially rigid pieces that generally or substantially take the form of polygons.

In the present disclosure, “substantially” should be considered to precede occurrences of terms such as “polygon,” “regular polygon,” and any other term(s) conventionally associated with planar two-dimensional Euclidian geometry, unless said term is preceded by an explicit modifier such as “perfect” or “Euclidian.” Those of skill in the art will recognize that geometrical shapes closely related to their Euclidian counterparts or versions can be projected, laid, adapted, and/or disposed onto or upon spherical surfaces with suitable adjustments as compared to their Euclidian versions, and that such spherical non-Euclidian versions of such shapes can be referred-to by their common (Euclidian) names without confusion. Further in the present disclosure, “substantially” should be considered to precede occurrences of the term “spherical,” (unless said term is preceded by an explicitly limiting modifier) such that nearly-spherical three-dimensional shapes such as oblate spheroids, prolate-spheroids, ellipsoids, pear-shapes, and the like, are considered to be within the scope of “spherical.” Furthermore, it is to be appreciated that limitations on manufacturing precision, etc., generally may impose limits on the degree to which a particular mathematically-defined shape can be approached by a real physical model.

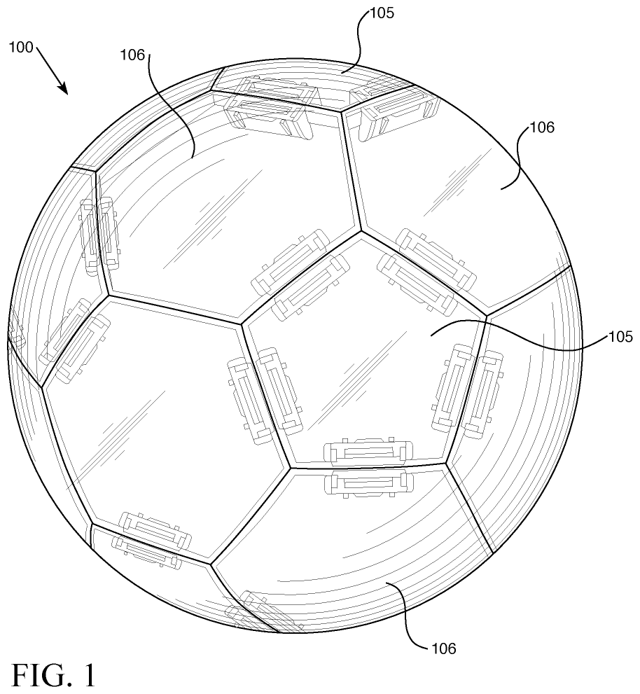

FIG. 1 is a schematic perspective view of a globe assembly 100 that can be an assemblage of a plurality of substantially rigid pieces 105, 106. In some or all of the Figures, assembly 100 and pieces 105, 106 are illustrated as being clear, but this is not necessary and the disclosed globe assemblies, pieces, and/or components thereof are not limited to being clear. In some embodiments, and as illustrated for globe 100 of FIG. 1, globe assemblies can be assemblages of pieces that substantially take the form of regular polygons. Globe 100, as illustrated in FIG. 1, can include a quantity of regular pentagon pieces 105 and a quantity of regular hexagon pieces 106. Globe 100 of FIG. 1 can include twelve regular pentagon pieces 105 and twenty regular hexagon pieces 106, and together, these thirty-two pentagon and hexagon pieces can be attached together to form an essentially complete globe. In some other embodiments, quantities other than thirty-two of regular polygon pieces can be attached together to form essentially complete globes. In still other embodiments, quantities of non-regular polygon pieces can be attached together to form essentially complete globes. In yet other embodiments, quantities of both regular polygon pieces and non-regular polygon pieces, which can include quasi-regular polygon (as defined herein) pieces, can be attached together to form essentially complete globes. In yet still other embodiments, quantities of pieces that can include non-polygon pieces can be attached together to form essentially complete globes.

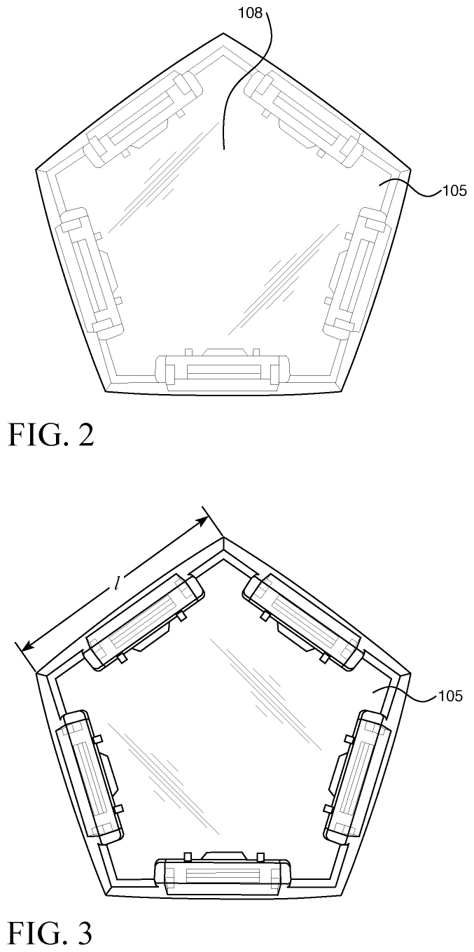

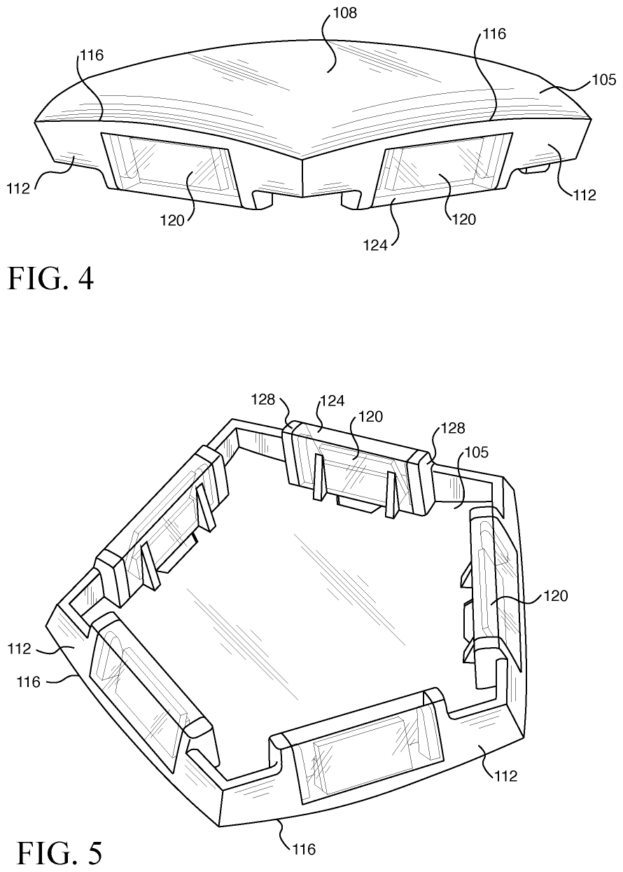

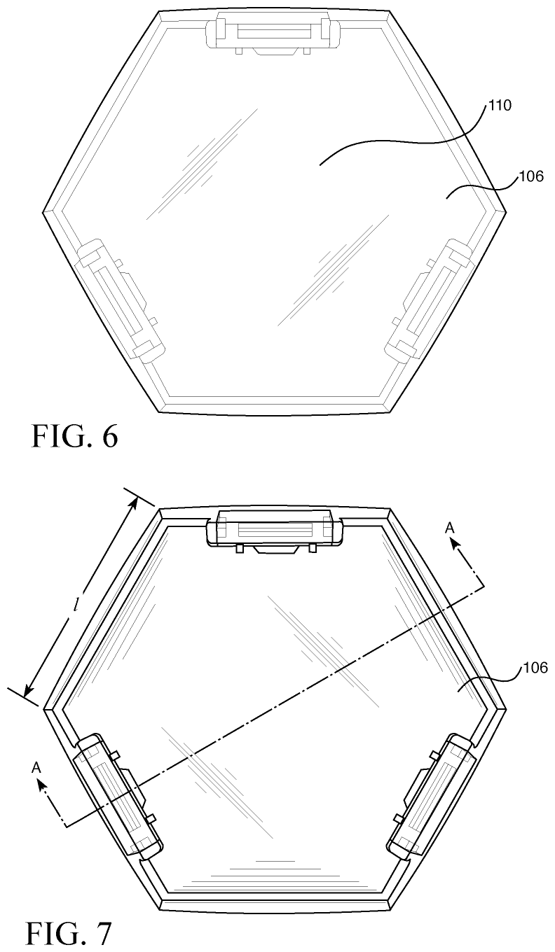

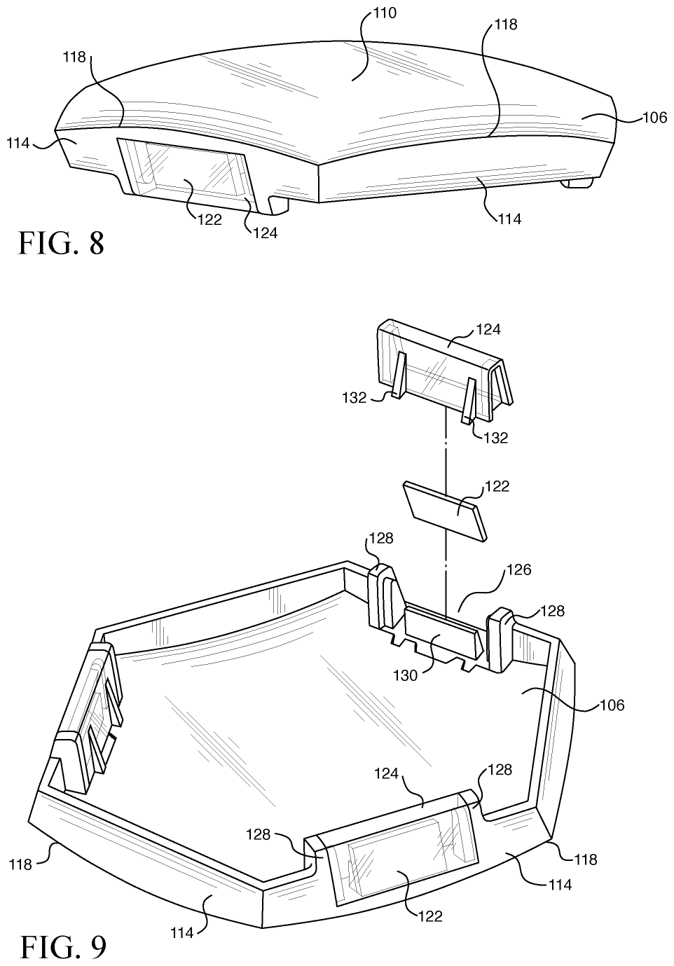

FIGS. 2-5 provide various schematic views of pentagonal piece(s) 106 and FIGS. 6-9 provide various views of hexagonal piece(s) 105 of the globe 100 of FIG. 1. FIG. 2 is a schematic top plan view of a pentagonal segment 105. FIG. 3 is a schematic bottom plan view of a pentagonal segment 105. FIG. 4 is a schematic side perspective view of a pentagonal segment 105. FIG. 5 is a schematic bottom perspective view of a pentagonal segment 105. FIG. 6 is a schematic top plan view of a hexagonal segment 106. FIG. 7 is a schematic bottom plan view of a hexagonal segment 106. FIG. 8 is a schematic side perspective view of a hexagonal segment 106. FIG. 9 is a schematic bottom perspective view of a hexagonal segment 106.

Globe pieces 105, 106 can be manufactured by any suitable process, and of any suitable material. In some embodiments, pieces 105, 106 can be milled, thermoformed, or injection-molded, etc. In some embodiments, globe pieces 105, 106 can be formed by additive manufacturing such as “3D printing.” In some embodiments, pieces 105, 106 can be manufactured with a combination of processes. In some embodiments, pieces 105, 106 can include one or more polymers, such as polycarbonate, polyethylene terephthalate, polypropylene, and the like. In some embodiments, pieces 105, 106 can include one or more metals. In some embodiments, pieces 105, 106 can comprise one or more natural materials, such as wood.

In some embodiments, substantially rigid pieces of a globe, such as pieces 105 and 106 of globe 100 of FIG. 1, can each have a curved outer major surface (108 and 110, respectively) that substantially forms a portion of the surface of the globe. The globe 100 can be a substantially spherical globe, or any other suitable globe shape that may be desired. In some such cases, the outer major surfaces 108, 110 of the pieces 105, 106 of the globe 100 can be shaped such that when the pieces are assembled to each other, the outer major surfaces of the assembled pieces can substantially collectively form a portion (or an entirety) of the surface of a spherical globe.

Pentagonal pieces 105 and hexagonal pieces 106 can be bounded by edges that demark a substantially regular polygon, with all of the edges of all of the plurality of pieces having substantially identical length. More specifically, in some embodiments each pentagonal piece 105 (hexagonal piece 106) can be bounded by a substantially flat edge 112 (114), as shown, for example, in FIGS. 4 and 5 (8 and 9). Each substantially flat edge 112 (114) can be bounded on the side corresponding to the outer major surface of the globe 100 by a curved edge 116 (118) with a curvature substantially corresponding to the curvature of the outer major surface of the globe. Substantially identical lengths of edges of pentagonal 105 and hexagonal 106 pieces, and substantially matching curvatures of curved edges 116 and 118 can contribute to substantially seamless and minimally noticeable transitions between pieces where they meet at the surface of globe 100, which can contribute to a perception that an assembled globe 100 is a single unit, even while it is actually an assemblage of multiple pieces.

Attachment systems are contemplated in the present disclosure that are structured and configured to attach pieces of globe assemblies together. In some embodiments, an attachment system of a globe assembly can be structured and configured to attach at least some adjacent edges of globe pieces together. In some embodiments, an attachment system of a globe assembly can be structured and configured to attach at least one edge of each of the plurality of pieces of the globe assembly to an adjacent edge of another of the plurality of pieces. An attachment system of a globe assembly can be structured and configured such that the globe can have sufficient structural integrity to substantially maintain a spherical shape under its own weight, or under other use scenarios, such as being handled with reasonable care. Handling with “reasonable care” can include, for example and without limitation, being handheld and rotated to allow viewing of any/all sides of the globe; being handed from person to person; being set down and picked up; holding with sufficient grip such that the person holding the globe does not reasonably fear dropping the globe; and the like. Handling that might exceed “reasonable care” could include, for example and without limitation, throwing or kicking a globe; squeezing a globe with force beyond that necessary to hold the globe; playing with globe as a toy ball; and so on. In some embodiments, a globe assembly can include a robust attachment system that could be expected to substantially maintain a spherical shape of the globe even under handling scenarios that may exceed “reasonable care.” In some embodiments, an attachment system of a globe assembly can be structured and configured such that a partial or incomplete globe assembly (for example, a globe assembly that is missing one or more pieces that would be needed to complete a spherical shell) can have sufficient structural integrity to substantially maintain a spherical shape (save for the missing pieces) under its own weight, such as when resting upon a tabletop or other appropriate surface.

In some embodiments, and as illustrated for globe 100 of FIG. 1, a globe assembly can use attachment devices that can include magnets. Some or all edges of pieces 105, 106 can incorporate magnets such that adjacent edges of pieces can be attached to each other via attractive magnetic forces.

In some embodiments, and as illustrated for globe 100 of FIG. 1 and pieces 105, 106 illustrated in FIGS. 2-9, every edge of each pentagonal piece 105 can include a magnet 120 with an outwardly facing first polarity (e.g., North or South magnetic pole), and every other edge of each hexagonal piece 106 can include a magnet 122 with an outwardly facing second polarity (e.g., the other magnetic pole). Magnets 120 and 122 can be structurally identical save for orientation.

In some embodiments of a thirty-two piece (twelve pentagonal pieces 105 and twenty hexagonal pieces 106) globe assembly, all five edges of each pentagonal piece include magnets with outwardly-facing first polarity, and every other edge (and only every other edge) of each hexagonal piece includes a magnet, with that magnet exhibiting an outwardly-facing second polarity. Such a configuration has the benefit that the globe 100 can be assembled without same-pole magnetic repulsion conflicts. In such a configuration, when appropriately assembled, each edge of every pentagonal piece 105 can be magnetically attached on all sides to a bordering edge of a hexagonal piece 106, and no bordering edges of hexagonal pieces are magnetically attached (as there are no magnets on such hexagonal-hexagonal bordering edges). For purposes of further discussion herein, the configuration described in this paragraph can be described as the “12P[5/5]20H[3/6]” configuration.

Variations on the 12P[5/5]20H[3/6] configuration are possible. In some variations, some of the magnets of the 12P[5/5]20H[3/6] configuration are removed, but none are added. Some such configurations may still have sufficient magnetic attachment between pieces to maintain structural integrity, such as being able to substantially maintain a spherical shape under their own weight, or when being handled with reasonable care. In some other variations, all of the magnets of the 12P[5/5]20H[3/6] configuration are included, and further magnets can be added to some or all edges of hexagonal pieces that do not include magnets in the 12P[5/5]20H[3/6] configuration. In such variations, hexagonal pieces may be keyed by magnetic polarities to fit only in certain orientations, whereas in the 12P[5/5]20H[3/6] configuration, hexagonal piece may fit in any of three rotations. This could be used advantageously to magnetically permit only particular desired assembly configurations, which may be desirable when the surface of the globe includes an image or images that, for correct appearance, depend(s) on a particular assembly configuration.

Magnets 120, 122 can be included or integrated with edges of globe pieces 105, 106 in any suitable manner. FIG. 9, which is a schematic bottom perspective view of a hexagonal segment 106, illustrates aspects of a magnet integration arrangement that can be used for globe pieces 105, 106 of the present disclosure. In FIG. 9, an exploded view is provided for one of the three edges of hexagonal piece 106 that includes a magnet 122. The illustrated magnet integration mechanism can include a magnet jacket 124 that can attach to a magnet receptacle 126. The receptacle 126 can include side pillars 128 and a backstop 130 structured to support magnet 122/120. Jacket 124 can include buttresses 132 oriented to support the jacket against contact forces between the jacket and an edge of a neighboring globe piece. Buttresses 132 also can assist in assembly of the jackets 124 to the receptacles 126. Receptacle 126 and jacket 124 can include further complementary structures for mechanical robustness and/or to assist in assembly. Jacket 124 and receptacle 126 can be attached in any suitable manner. In some embodiments, jacket 124 and receptacle 126 can be adhered together. In some embodiments, jacket 124 and receptacle 126 can include features such that they can be attached via a snap fit, and/or they can be toleranced such that they can be attached via friction fit. In some embodiments, the magnet integration arrangement of jacket 124 and receptacle 126 can be structured and configured such that, when they are attached, side pillars 128 and jacket 124 present substantially flush surface portions of the substantially smooth edge 114 (112) into which they are integrated.

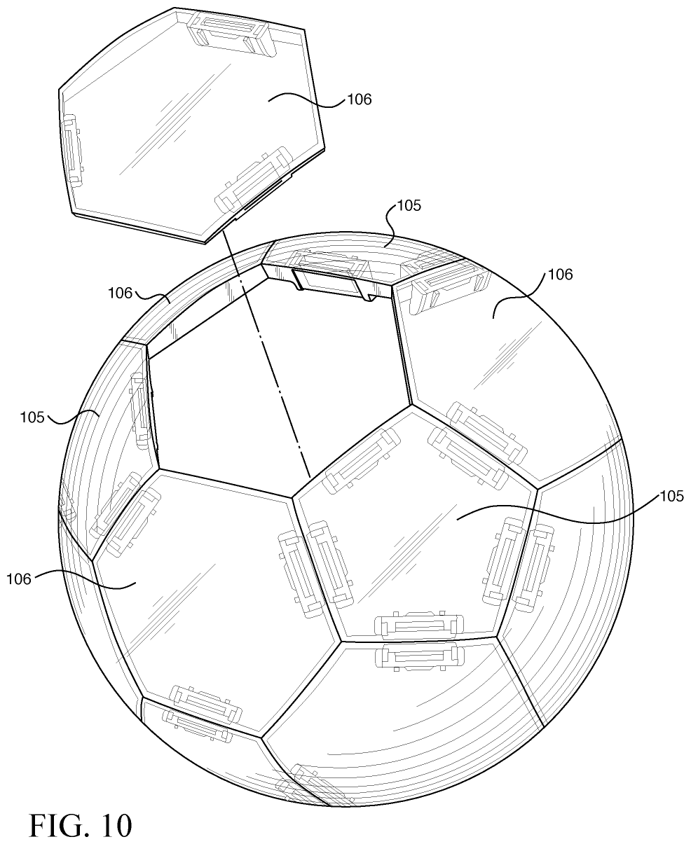

FIG. 10 is a schematic perspective view of a globe assembly 100 that is essentially fully assembled save for a single hexagonal piece 106, to illustrate the assemblability of the globe.

Other attachment system configurations are contemplated in the present disclosure. Some attachment devices that can be employed between edges of pieces can be polarized (as are magnets), such as hook-and-loop fasteners (e.g., Velcro® brand fasteners), and various other mechanical devices, with which same polarity devices do not attach well or at all, but opposite polarity devices can attach securely. Some further examples of attachment devices that may be polarized can include devices that exploit interference, press, or friction fits, such as peg-and-hole joints, and various snap-fit devices, such as ball-and-socket joints and any others that exploit annular and/or cantilever snap-fit techniques. Some other attachment devices that can be employed can be non-polarized, such as adhesives such as glue, cement, double-sided adhesive tapes, and the like, which can be used between edges of globe pieces. Some attachment technologies may be easily reversible and repeatable (which could be advantageous, e.g., for using globes as puzzles to be solved repeatedly), and some attachment technologies may be difficult or impossible to reverse once globe pieces are attached (which could be advantageous for globes where disassembly is discouraged or inappropriate, etc.). In some examples, all pieces of a globe can be essentially permanently attached (for example, via adhesives) such that the globe is not readily disassemblable. In some other examples, one or more subsets of pieces of a globe can be essentially permanently attached (without all pieces of the globe being permanently attached) such that the permanently-attached subsets and any other not-permanently-attached globe pieces can be subsequently assembled, for example, via magnets.

As stated elsewhere herein, globes facilitate appreciation of spatial information in ways with distinct advantages over more common two-dimensional flat media. Traditional methods of globe production have disadvantages that can make it difficult to manufacture accurate globes (one aspect of accuracy relating to properly placing features on a globe), and producing custom globes can be cost prohibitive. Challenges to producing high-quality imagery on globes can arise from the facts that globes have surfaces curved on multiple axes, but much or most printing technology is directed toward printing on flat surfaces.

Globe configurations of the present disclosure make possible cost-effective and accurate production of globes with highly customizable imagery. Pieces of globes of the present disclosure can be printed individually and then assembled together after printing. By limiting the scope of individual printing operations to individual globe pieces, challenges to printing on curved globe surfaces can be made tractable.

In some embodiments, globe pieces can be inkjet printed. In some embodiments, one or more globe pieces can be laid flat on a horizontal surface with their curved outer major surfaces facing upward, and the piece(s) can be inkjet printed upon via a print head that can scan horizontally in x- and y-directions. In some of these embodiments, the print head may be capable of being scanned in the vertical z-direction such that the print head can follow the curved surface of the piece. In some other embodiments, the print head may scan horizontally in x- and y-directions over the curved surface of a piece, while remaining at an essentially fixed position in the vertical x-direction (that is, the print head may scan in an x-y plane at a fixed value of z). In either scenario, the challenge of printing on the curved outer major surfaces of globe pieces can be reduced by limiting the amount of vertical (z-direction) variation across the printable area of a single piece. Judicious segmentation of a globe in to globe pieces, as in globe assemblies of the present disclosure, can reduce the amount of vertical variation that need be addressed when printing each globe piece.

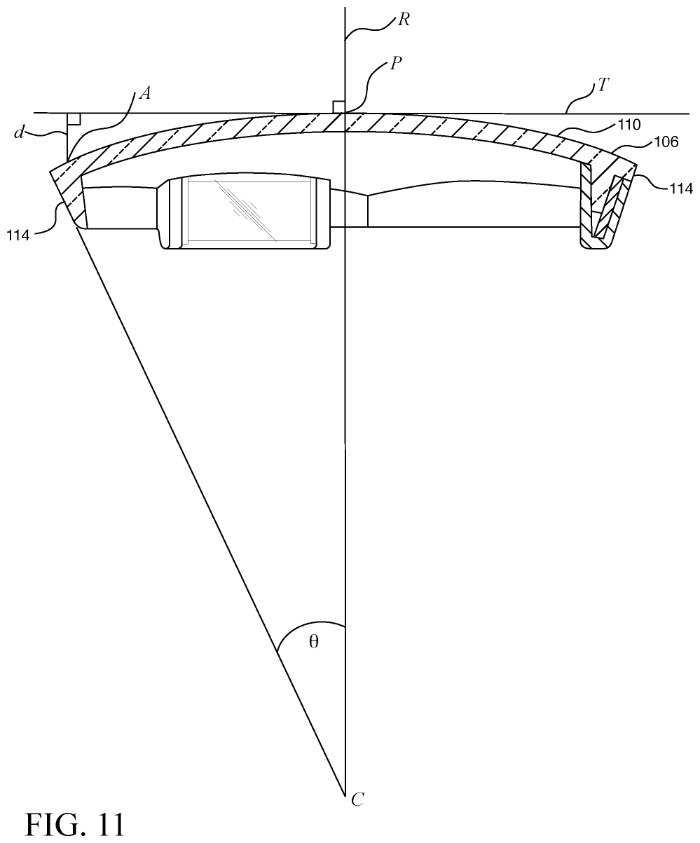

The discussion of vertical variation for printing on pieces may be further elucidated in reference to FIG. 11, which is a schematic cross-sectional view of a hexagonal piece 106 along the line A-A marked in FIG. 7, with reference lines added to illustrate geometrical relationships. Hexagonal piece 106 is formed in relation to a globe assembly having a center at C. Radial line R intersects globe center C and point P, which is at the center of the outer major surface 110 of piece 106. A line or plane T is tangent to piece 106 at P. An arbitrary point A on the outer major surface 110 of the hexagonal piece 106 is at a distance d from the tangent line/plane T. If a print head whose motion is constrained to a horizontal plane is positioned essentially touching the outer major surface 110 of piece 106 at P, then when the print head is positioned above point A, the distance between the print head and the outer major surface at A is the “drop” d. In practice, a print head may require a minimum separation distance between itself and a surface being printed, but drop d can still be the difference between the height of the print head above outer major surface 110 at point A vs its height at point P. The angle θ between radial line R and a radius directed toward an edge 114 (or 112 for pentagonal piece 105) can factor into the calculation of drop d. For a twelve regular pentagon 105, twenty regular hexagon 106 configuration, θ can be about 18.69° and 20.90° for the pentagon and hexagon pieces, respectively.

Drop d can be a significant quantity for printing, as the quality of printing delivered by a printer such as an inkjet printer may be dependent upon the height of the print head above the surface being printed. For an inkjet printer, the total drop (drop d plus any nominal or minimum separation between the print head and the surface being printed) can be a distance that an ink droplet drops or otherwise travels between the print head and the surface being printed upon. For some printers, print quality may suffer as the drop increases beyond an optimal or reference value. In globe assemblies of the present disclosure, individual globe pieces can be limited in size such that they can be printed upon without exceeding desired values of total drop.

More particularly, given knowledge of how the quality of printing achievable with particular printing mechanisms can be dependent upon print head to surface separation (i.e., drop), the present disclosure provides the insight that shapes and sizes of globe pieces can be specifically selected to limit the amount of drop d associated with the pieces. With regard to shape selection, regular polygon pieces, such as pieces 105 and 106, can be desirable for globe assemblies as the average drop across the printable outer major surface can be minimized as compared to an irregular polygon having the same area and number of sides. With regard to size selection, a globe size (parameterized, for example, by globe diameter) can be selected based upon a desired maximum allowable drop, which can correspond to a minimum acceptable print quality. For a twelve regular pentagon, twenty regular hexagon complete globe configuration, such as that illustrated in FIG. 1, a maximum drop dₘₐₓ (which occurs at any of the six hexagon vertices) of 8.04 mm is calculated for polygons of side length l (labeled in FIGS. 3 and 7) of 1.50 inches (3.81 cm), corresponding to globe diameter of 7.32 inches (18.6 cm). Maximum drop of 6.7 mm is calculated for polygon side length 1.25″ (3.18 cm) and globe diameter 6.10 inches (15.5 cm). Maximum drop of 5.36 mm is calculated for polygon side length 1.00″ (2.54 cm) and diameter 4.88 inches (12.4 cm). Maximum drop of 9.1 mm is calculated for polygon side length 1.77″ (4.49 cm) and diameter 8.50 inches (21.6 cm). Any of these examples of globe dimensions may correspond to a desired level of achievable print quality, corresponding to each example's maximum drop. In general, smaller maximum drops can correspond to higher achievable print quality. Accordingly, globe assemblies assembled of pieces 105, 106 having shorter side lengths l can have higher print quality than globes with longer side lengths. In an embodiment, a globe assembly includes regular pentagon 105 and hexagon 106 pieces that have a side length that is within a range from about 1 inch to about 1.5 inch. In an embodiment, a globe assembly includes regular pentagon 105 and hexagon 106 pieces that have a side length that is within a range from about 1 inch to about 1.25 inch. In an embodiment, a globe assembly includes regular pentagon 105 and hexagon 106 pieces that have a side length that is within a range from about 1.25 inch to about 1.5 inch.

While the discussion of “drop” has been framed above in reference to an arrangement in which a globe piece is laid flat on a horizontal surface and a print head is scanned in a plane horizontally above the piece, other printing orientations are possible. In other orientations, an ink droplet may not literally drop a distance d, but the concept of “drop” may be applied more generally to describe the separation between a curved surface and print head whose motion is constrained to a plane.

In some methods of the present disclosure, dimensions of globe pieces can be selected in order not to exceed a total drop value, based upon a selected printing technology and the quality achievable with that printing technology in view of print head to printing surface drop.

The twelve pentagon, twenty hexagon configuration described herein and illustrated in at least FIGS. 1 and 10 is just one example of the many possible ways to tesselate a globe as contemplated in the present disclosure. The twelve pentagon, twenty hexagon spherical configuration can be described as a spherical polyhedron that is a based on a truncated icosahedron (an icosahedron is a Platonic solid that has twenty triangular faces; when each of the twelve vertices is truncated, twelve pentagonal faces are formed, and each formerly triangular face acquires three more edges to become a hexagon).

Many other tessellation patterns are possible. The present disclosure contemplates selecting various tessellation patterns for various globe assemblies depending on a plurality of design considerations, some of which trade off against each other. For example, a tessellation that provides a greater number of globe pieces can be advantageous for print quality, as each globe piece can be smaller, which can mean each piece exhibits less maximum drop. However, a greater number of globe pieces can mean higher production costs. A tessellation that provides a smaller number of globe pieces can thus be advantageous for cost and other production considerations. However, if a smaller number of pieces results in greater maximum drop, printing quality may be negatively impacted.

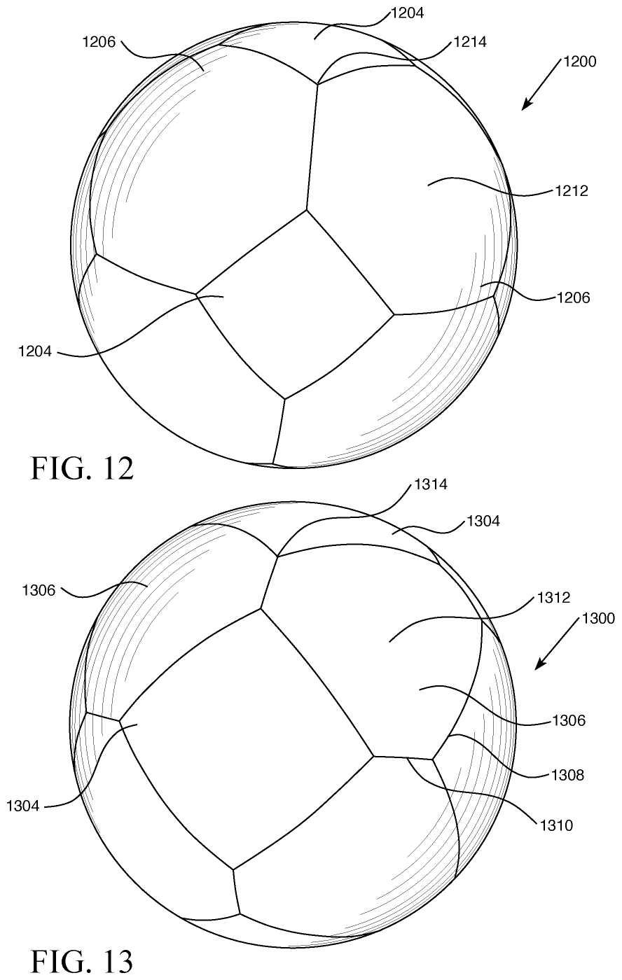

FIGS. 12 and 13 are schematic perspective views of further globe assemblies contemplated by the present disclosure. Globe assembly 1200 of FIG. 12 can be described as a spherical polyhedron that is a based on a truncated octahedron. An octahedron is a Platonic solid that has eight triangular faces; when each of the six vertices is truncated, six square pieces 1204 can be obtained, and each formerly triangular face acquires three more edges to become a hexagon 1206. In the tessellation pattern of globe assembly 1200, the truncations of the six vertices of the original octahedron are performed or located such that six squares pieces 1204 and eight regular hexagonal pieces 1206 result. Compared with the twelve pentagon, twenty hexagon configuration of FIGS. 1 and 10 having thirty-two globe pieces, globe assembly 1200 of FIG. 12 includes just fourteen globe pieces, which can simplify production and reduce costs considerably. However, for spherical globes of the same radius, at least some of the pieces of globe 1200 exhibit considerably greater drop than the pieces of globe 100, with possible negative impacts on print quality.

The present disclosure provides further insights into ways to manage the amount of maximum drop of globe pieces. Globe assembly 1300 of FIG. 13 illustrates another possible way to truncate an octahedron as compared with globe assembly 1200. Globe assembly 1300 can be described as a spherical polyhedron that is a based on a truncated octahedron, with a different truncation arrangement than that of globe assembly 1200. The truncation arrangement of globe assembly 1300 results in square pieces 1304 that are larger than the square pieces 1204 of globe assembly 1200 (for globes of equal radius). Further, the truncation arrangement of globe assembly 1300 results in hexagonal pieces 1306 that are smaller than the hexagonal pieces 1206 of globe assembly 1200 and that are not bounded by regular hexagons. Each non-regular hexagonal pieces 1306 can include alternating first edges 1308 of a first length and second edges 1310 of a second length. Hexagonal faces 1306 can be described as being bounded by a quasi-regular polygon, where in the present disclosure, a quasi-regular polygon is defined as having alternating edges of a first length and of a second length, and equal angles between all edges.

Comparing globe pieces of globe assemblies 1300 and 1200 (for spherical globes of equal radius), hexagonal pieces 1306 of globe assembly 1300 exhibit less maximum drop than hexagonal pieces 1206 of globe assembly 1200. This is a geometrical consequence of the different truncation arrangements of globes 1200 and 1300, a result of which is that the distance from the center 1312 to a vertex 1314 of a hexagon 1306 is shorter than the distance from the center 1212 to a vertex 1214 of a hexagon 1206. Square pieces 1304 of globe assembly 1300 are larger than square pieces 1204 of globe assembly 1200, and exhibit greater maximum drop. The difference in maximum drop between pieces 1304 and 1306 of globe assembly 1300 is smaller than the difference in maximum drop between pieces 1204 and 1206 of globe assembly 1200, a consequence of the pieces 1304, 1306 of globe assembly 1300 being more closely matched in size than the pieces 1204, 1206 of globe assembly 1200.

The present disclosure provides the insight that selection of truncation patterns can be used to affect maximum drop of globe pieces. The spherical tessellation patterns of globes 1200 and 1300, while both being truncated octahedrons, are characterized by truncation at different levels (with the truncation level being related to the location of the truncation plane relative to the center of the polyhedron). Selection of truncation level can be used to affect or control maximum drop of globe pieces. Just as an octahedron can be truncated at a level that produces six squares and eight regular hexagons (e.g., globe assembly 1200) or at another level that produces six squares and eight quasi-regular hexagons (e.g., globe assembly 1300), an icosahedron can be truncated at a level that produces twelve pentagons and twenty regular hexagons (e.g., globe assembly 100) or at another level that produces twelve pentagons and twenty quasi-regular hexagons.

More generally, the selection of tessellation patterns can be used to affect or control maximum drop of globe pieces. Tessellation patterns contemplated for use for globes of the present disclosure include, but are not limited to, those listed below (in addition to any others described elsewhere herein), whose names are followed by a brief description of the constituent tiles of the tessellation:

| | |
|---|---|
| Tetrahedron | 4 regular (equilateral) triangles; |
| Truncated tetrahedron | 4 regular (equilateral) triangles and 4 |
| | regular or quasi-regular hexagons (depending |
| | on truncation level); |
| Cube | 6 squares; |
| Truncated cube | 8 regular (equilateral) triangles and 6 |
| | regular or quasi-regular octagons; |
| Octahedron | 8 regular (equilateral) triangles; |
| Truncated octahedron | 6 squares and 8 regular or quasi-regular |
| | hexagons; |
| Cuboctahedron | 8 regular (equilateral) triangles and 6 |
| | squares; |
| Truncated cuboctahedron | 12 squares, 8 regular or quasi-regular |
| | hexagons, and 6 regular or quasi-regular |
| | octagons; |
| Icosahedron | 20 regular (equilateral) triangles; |
| Truncated icosahedron | 12 pentagons and 20 regular or quasi-regular |
| | hexagons; and |
| Rhombicuboctahedron | 8 regular (equilateral) triangles, 6 squares, |
| | and 12 squares or rectangles). |

Further tessellation patterns contemplated for use include N-sided prisms generally (triangular prism, pentagonal prism, hexagonal prism, and so on); N-sided antiprisms generally; N-sided trapexohedrons generally; and N-sided bipyramids generally.

As discussed herein at length in the examples of truncated octahedron globe assemblies 1200 and 1300, truncations in general can be executed at different levels, which can result in polygonal globe pieces with less or more drop. Prisms and anti-prisms can be lengthened or shortened resulting in unique tessellations, similarly to how polyhedron truncations can be executed at different levels.

The present disclosure further contemplates globes incorporating tessellation patterns that include tiles that are outline by or otherwise follow or resemble irregular polygons. Some irregular polygon tessellation patterns examples include:

| | |
|---|---|
| Deltoidal icositetrahedron | 24 (identical) irregular quadrilaterals; |
| Rhombic dodecahedron | 12 (identical) rhombuses; and |
| Pentagonal icositetrahedron | 24 (identical) irregular pentagons. |

Considering the tessellation patterns explicitly identified herein, as well as other tessellation patterns that may be suitable, the present disclosure contemplates globes as described herein that can include four (4) pieces, six (6) or fewer pieces, eight (8) or fewer pieces, twelve (12) or fewer pieces, fourteen (14) or fewer pieces, twenty (20) or fewer pieces, twenty-four (24) or fewer pieces, twenty-six (26) or fewer pieces, and thirty-two (32) or fewer pieces.

Tesselations having substantially larger numbers of tiles are also possible. In some examples, a globe can include 12 pentagons and 110 hexagons. In some examples, a globe can include 12 pentagons and 260 hexagons.

Considering the tessellation patterns explicitly identified herein, as well as other tessellation patterns that may be suitable, the present disclosure contemplates globes as described herein that can include tiles of a single type (i.e., shape and size), tiles of two types, and tiles of three types. Globes that include greater than three types of tiles are also contemplated.

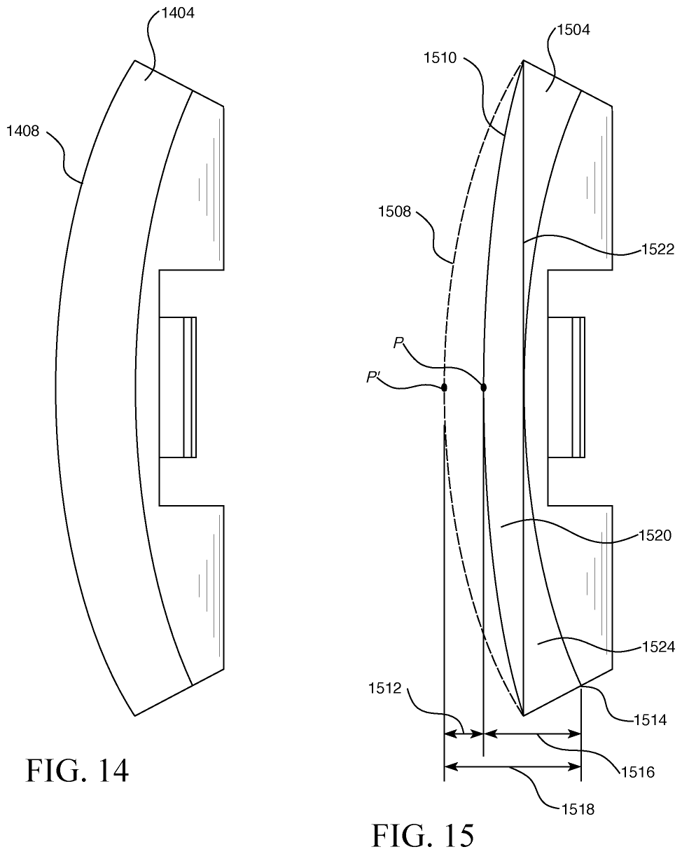

The present disclosure provides further ways to manage the amount of maximum drop of globe pieces by specifying variations in shape of the outer major surface of globe pieces. FIG. 14 is a schematic side view of a square globe piece 1404, which can be the same as, or similar to, one of pieces 1204 and 1304 of globe assemblies 1200 and 1300, respectively. (The use of square globe pieces in the examples of FIGS. 14 and 15 is arbitrary, with the same principles applying to globe pieces having other shapes.) Similar to other globe pieces described herein, such as pieces 105, 106, 1204, 1206, 1304 and 1306, globe piece 1404 can have an outer major surface 1408 with a spherical shape, such that when it is attached to other globe pieces of appropriate shape, together they can combine to form a substantially ideal spherical shape, as illustrated for example in FIGS. 12 and 13.

In order to manage drop, the present disclosure provides the insight that pieces with outer major surfaces that vary from purely or essentially spherical shapes can be incorporated into globe assemblies, with the benefit that maximum drop can be decreased, enabling improved print quality. FIG. 15 is a schematic side view of a square globe piece 1504, similar in many aspects to square globe piece 1404 of FIG. 14, but differing in the shape of its outer major surface 1510. In FIG. 15, broken line curve 1508 represents a reference spherical globe surface, essentially like the spherical shape of the outer major surface 1408 of globe piece 1404. This reference spherical globe surface represented by curve 1508 is the shape that the piece 1504 would have, if it were to contribute to a substantially ideal spherical shape for a complete globe assembly. As illustrated, outer major surface 1510 can vary from the reference spherical globe surface represented by curve 1508, and is generally flatter, with a maximum height at the center P of the piece 1504 being lower (i.e., closer to the center of the globe assembly of which the piece is a component) than the maximum height at the center P′ of the reference spherical globe surface represented by curve 1508. The difference in maximum height due to the flatter shape of outer major surface 1510 relative to curve 1508 is shown as 1512. With the lower maximum height at P relative to P′, maximum drop is also reduced. The maximum drop (from the center at P to a low point of surface 1510 at a vertex 1514) of piece 1504 is shown as 1516. This maximum drop 1516 is less than a reference maximum drop 1518 for a piece having an outer major surface with the reference spherical globe surface represented by curve 1508. Thus, by adopting a flatter shape for outer major surface 1510 of piece 1504, maximum drop for the piece can be reduced relative to a reference spherical surface, enabling higher quality printing.

In the present disclosure, a “flatter” shape for an outer major surface of globe piece can be any shape that generally provides for less maximum drop for the piece, as compared with a reference spherical shape. The flatter shape need not necessarily include any area that is flat in the sense of being planar. The flatter shape need not necessarily vary from the reference spherical shape for all portions of the outer major surface. For example, for piece 1504, area 1520 of outer major surface 1510, bounded by rim 1522, can be flattened, and area 1524 can essentially follow a reference spherical globe surface, but this is just an example. In other examples, an outer major surface of a globe piece can be flattened such that at all parts of the surface, the flatter shape varies from the reference spherical shape. In general, a flatter shape for an outer major surface can be arbitrarily-shaped, so long as the shape provides for less maximum drop for the piece, as compared with a reference spherical shape. For globe pieces having outer major surface that are flattened, the flattening can be such that a maximum drop for the outer major surfaces of the pieces does not exceed a pre-determined value, such as about 8.0 mm.

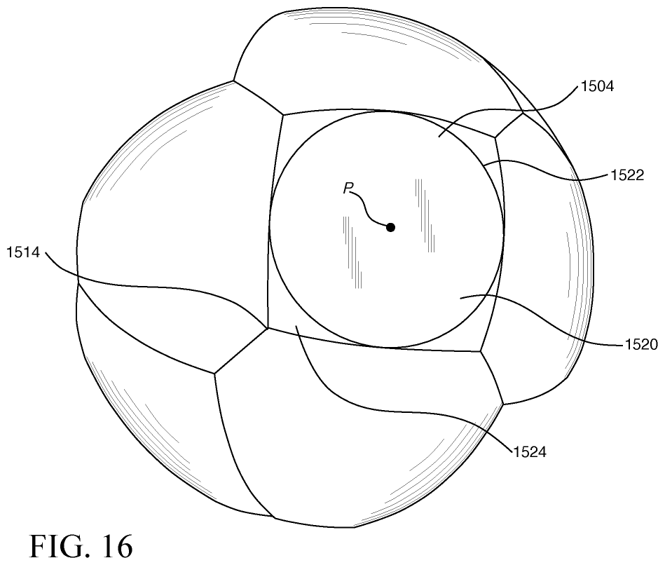

Another perspective of square globe piece 1504, with areas 1520, 1524, and rim 1522, is provided in FIG. 16, which is a schematic perspective view of multiple globe pieces, including piece 1504, that are positioned with respect to each other to provide at least a portion of a globe assembly. While not necessarily explicitly illustrated in FIG. 16, any of the other globe pieces of the globe assembly of FIG. 16 can include flattened outer major surfaces, and any globe contemplated in the present disclosure can include any combination of globe pieces with flattened and non-flattened outer major surfaces.

Globe assemblies of the present disclosure can include any suitable imagery. In some embodiments, a photographic image that captures a view in all or a majority of directions surrounding a location can be printed on to a globe surface. Such a photograph may be commonly referred to as a “360 degree” or “Virtual Reality” (VR) image, and may capture image information in all, most, or a substantial portion of the 4π solid angle surrounding a location.

In some embodiments, images of substantially different subject matter can be included on different pieces of a globe assembly. In some embodiments of the present disclosure, each of a majority of pieces of a globe assembly includes a printed image on its outer major surface that is different than any printed image of any of the other of the pieces of the globe assembly. In some cases, every piece of a globe assembly includes a different printed image on its outer major surface.

In some embodiments, some pieces of globe assemblies bear, display, or have similar, identical, and/or repeated images.

In some embodiments, images can be printed upon substantially transparent or clear globe pieces. In some instances, imagery may be visible both on a side of the globe closest to a viewer, and/or images may be seen on an opposite side, through a clear portion of the globe. In some embodiments, a light source may be disposed within a globe assembly of the present disclosure. Such an internal light source can provide illumination for imagery on the globe surface, and/or could project imagery outward from the globe, such as for a planetarium application.

Any suitable printing technology may be used for globes of the present disclosure. As mentioned elsewhere herein, in some embodiments inkjet printing can be used to print images directly onto globe pieces. Any suitable printing steps can be included in methods of the present disclosure. In some cases, primer can be applied to globe pieces prior to printing. In the present disclosure, printing onto a globe piece onto which primer has been applied previously is considered printing “directly” onto the globe piece. In some other cases, pieces can be printed onto without prior primer application. In some cases, additional non-image layers or coatings can be printed or otherwise applied onto pieces, such as a clear coat and/or a top coat, etc.

In some embodiments, images can be printed onto substrates such as films or adhesive stickers separately from globe pieces and then later applied to the pieces. In some embodiments, globes do not include any globe pieces onto which an image-bearing substrate such as a film or adhesive sticker has been attached. In some embodiments, for each globe piece that includes a printed image on its outer major surface, the printed image is printed directly upon the outer major surface, and is not printed upon a substrate that is attached to the outer major surface.

Images on globe assemblies of the present disclosure can include maps or other imagery of the Earth, other planetary bodies, celestial bodies, and the like. Any suitable detail can be included on such planetary globe models. The tiled nature of the globe assemblies can make it possible to update a globe without necessarily replacing all pieces of a globe. For example, if a political boundary or place name changes, or if a new geographic feature appears (due, for example, to volcanic activity), replacement tiles for the relevant region can be swapped-in while retaining tiles for unchanged regions.

Imagery on globe assemblies of the present disclosure can include three-dimensional imagery, such as topographical relief of geographical features such as mountain ranges. Three-dimensional imagery or relief on the outer major surface 108, 110 of a globe piece 105, 106 can be formed in any suitable manner, such as via injection molding, milling, additive manufacturing (e.g., 3D printing), and inkjet printing of multiple layers.

Globe assemblies with customizable features extending beyond images are contemplated. In some embodiments, globe assemblies can be configured such that accessories readily can be attached to globe pieces. For example, pieces 105, 106 can include one or more devices such as sockets, receptacles, magnets, etc., positioned to allow accessories such as game pieces to be attached to globe pieces.

The present disclosure further contemplates globe assemblies with additional structures internal and/or external to the globe shell (the shell being the globe formed by assembled globe pieces 105, 106). Such further structures could include models of planetary cores or other subsurface structure, orbiting rings, space elevators, and so on.

In some embodiments, globe tiles or pieces, such as pieces 105, 106, can be provided in a partial set that can be assembled, with additional pieces that are not part of the partial set, into a complete globe assembly, but the partial set alone may not include sufficient pieces to assemble into a complete globe. In some examples, such a partial set could be provided, without limitation, as replacement pieces for a globe set. In another example, multiple partial sets could be made available separately to end users, who could collect, trade, barter, etc., in order to accumulate sufficient globe pieces in order to assemble a complete globe. In another example, an accessory such as a globe base or stand (for example, to support a globe on a desk or off of a floor) can be provided, where the globe base or stand can include portions that essentially substitute for, or take the place of, one or more globe pieces. In this example, a set of globe pieces can be provided that, when assembled onto or with the globe base or stand, can result in a complete globe and base/stand assembly. In still another example, a set of globe pieces can be provided that, when assembled, form an incomplete globe, such as a globe that lacks pieces that would, if present, form a lower portion of the globe. Such an incomplete or partial globe can have advantages, such as stably resting in place (e.g., without rolling away) even without a stand or other support device, while the absence of the “missing” pieces may be relatively unimportant—for example, they could correspond to areas of the globe of minor interest (e.g., the bottom portion of a 360 photo globe might correspond to the relatively-uninteresting ground beneath the photo's vantage point). An incomplete or partial globe can be considered to exhibit a spherical shape for the portion(s) of the partial globe that are present, despite not forming a geometrically complete spherical shape.

Persons of ordinary skill in arts relevant to this disclosure and subject matter hereof will recognize that embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A globe, comprising:
a plurality of pieces structured to inter-attach to form a surface of a globe, each of the plurality of pieces having a curved outer major surface that is shaped to form a portion of the surface of the globe and that is curved on more than one axis, the plurality of pieces including:
a first quantity of substantially identically-shaped M-sided polygonal pieces, and
a second quantity of substantially identically-shaped N-sided polygonal pieces; and
an attachment system structured and configured to attach at least some adjacent edges of the plurality of pieces, the attachment system attaching at least one edge of each of the plurality of pieces to an adjacent edge of another of the plurality of pieces, the attachment system being configured such that the globe has sufficient structural integrity to substantially maintain a globular shape under its own weight,
wherein each of a majority of the plurality of pieces includes a printed image on its outer major surface, and
wherein the printed image is printed directly upon the outer major surface of each of the majority of the plurality of pieces by a print head.

2. (canceled)

3. The globe of claim 1, wherein:
each piece of the first quantity of substantially identically-shaped M-sided polygonal pieces is bounded by edges that demark a substantially regular polygon; and
each piece of the second quantity of substantially identically-shaped N-sided polygonal pieces is bounded by edges that demark a substantially regular polygon.

4-5. (canceled)

6. The globe of claim 3, wherein all of the edges of all of the plurality of pieces have substantially identical length, the M-sided polygonal pieces are pentagons and the N-sided polygonal pieces are hexagons.

7. The globe of claim 6, wherein the first quantity is twelve and the second quantity is twenty.

8-10. (canceled)

11. The globe of claim 1, wherein a maximum distance from the print head to the outer major surfaces of each of the majority of the plurality of pieces does not exceed a pre-determined value of about 8.0 mm.

12. (canceled)

13. The globe of claim 1, wherein the attachment system includes polarized attachment devices structured and configured to provide reversible and repeatable attachments, every edge of each M-sided polygonal piece including a polarized attachment device of a first polarity, and every other edge of each N-sided polygonal piece including a polarized attachment device of a second polarity.

14. The globe of claim 13, wherein the polarized attachment devices include magnets.

15. (canceled)

16. A method for providing a photo globe, comprising:
providing a plurality of pieces structured to inter-attach to form a surface of a globe, each of the plurality of pieces having a curved outer major surface that is shaped to form a portion of the surface of the globe and each of the plurality of pieces being bounded by edges that demark a substantially regular polygon, the plurality of pieces including at least a first quantity of substantially identically-shaped M-sided polygonal pieces and at least a second quantity of substantially identically-shaped N-sided polygonal pieces;
printing directly onto the outer major surface of each of a majority of the plurality of pieces with a print head, wherein motion of the print head is constrained to a plane while printing onto the outer major surface that is curved on more than one axis; and
providing an attachment system that is structured and configured to attach at least some adjacent edges of the plurality of pieces, the attachment system being configured such that the globe, when assembled via inter-attachment of pieces via the attachment system, has sufficient structural integrity to substantially maintain a globular shape under its own weight.

17. (canceled)

18. The method of claim 16, further comprising:
selecting a printer technology for the printing,
wherein providing a plurality of pieces includes selecting dimensions for the pieces of the plurality of pieces such that a maximum distance from the print head to the outer major surfaces of each of the majority of the plurality of pieces does not exceed a value of about 8.00 mm.

19. (canceled)

20. The method of claim 18, wherein selecting dimensions for the pieces of the plurality of pieces includes at least one of selecting a truncation level, and specifying flattening of the outer major surfaces of at least some of the plurality of pieces.

21. The method of claim 16, wherein providing an attachment system includes integrating a magnet with each of the plurality of pieces, including:
integrating a magnet with each edge of each of the first quantity of M-sided polygonal pieces, the M-sided polygonal pieces being pentagonal pieces, and the magnet being integrated such that it exhibits a first polarity; and
integrating a magnet with every other edge of each of the second quantity of N-sided polygonal pieces, the N-sided pieces being hexagonal pieces, and the magnet being integrated such that it exhibits a second polarity,
wherein all of the edges of all of the plurality of pieces have substantially identical length.

22-50. (canceled)

51. The globe of claim 1, wherein motion of the print head is constrained to a plane while printing onto the outer major surface of each of the plurality of pieces, and wherein the outer major surface is curved on more than one axis.

52. The globe of claim 14, wherein all of the edges of all of the plurality of pieces have substantially identical length, the M-sided polygonal pieces are pentagons and the N-sided polygonal pieces are hexagons.

53. The globe of claim 14, wherein the magnets are enclosed within the polarized attachment devices.

54. The globe of claim 53, the attachment system further including a magnet integration mechanism along each edge of each M-sided polygonal piece and every other edge of each N-sided polygonal piece, each magnet integration mechanism having a magnet jacket that attaches to a magnet receptacle, wherein the magnet for each edge having a polarized attachment device fits inside the magnet jacket.

55. The globe of claim 54, wherein the magnet jacket includes buttresses oriented to support the magnet jacket against contact forces between the magnet jacket and an edge of a neighboring piece.

56. The globe of claim 54, wherein each said magnet receptacle includes flanking side pillars and a backstop structured to support the magnet, and further wherein the magnet jacket attaches between the flanking side pillars and over the backstop.

57. The globe of claim 56, wherein the magnet jacket and the magnet receptacle can be integrated with each other such that, when they are attached, the flanking side pillars and the magnet jacket present substantially flush surface portions of a substantially smooth edge into which the flanking side pillars and the magnet jacket are integrated.

58. The method of claim 21, wherein each edge of each of the first quantity of M-sided polygonal pieces and wherein every other edge of each of the second quantity of N-sided polygonal pieces further include a backstop and a magnet jacket that is located between flanking side pillars and over the backstop.

59. The method of claim 58, wherein integrating each corresponding magnet includes aligning each magnet against the backstop and within the magnet jacket.
